(19) United States
(12) Patent Application Publication
(10) Pub. No.: US 2019/0069585 A1
(43) Pub. Date: Mar. 7, 2019

(54) Compositions of micronutrients and phytochemicals for optimal human health

(71) Applicant: Gerald Haase, Denver, CO (US)

(72) Inventor: Gerald Haase, Denver, CO (US)

(21) Appl. No.: 15/999,914

(22) Filed: Aug. 29, 2018

Related U.S. Application Data
(60) Provisional application No. 62/553,260, filed on Sep. 1, 2017.

(51) Int. Cl. A23L 33/105; A23L 33/155; A23L 33/16; A23L 33/175

(52) U.S. Cl. CPC A23L 33/105; A23V 2250/21; A23L 33/16; A23L 33/175; A23V 2002/00; A23V 2200/324; A23V 2200/322; A23V 2250/71; A23V 2250/712; A23V 2250/7042; A23V 2250/7044; A23V 2250/7046; A23V 2250/705; A23V 2250/7052; A23V 2250/7054; A23V 2250/7058; A23V 2250/706; A23V 2250/0616; A23V 2250/0612; A23V 2250/0634; A23V 2250/1642; A23V 2250/1626; A23V 2250/161; A23V 2250/1586; A23V 2250/1578; A23L 33/155

(57) ABSTRACT

A formulation comprising at least one phytonutrient, at least one hormone, at least one mineral, at least one dietary vitamin, at least one antioxidant, at least glutathione elevating agent, and at least one other nutrient, and mixtures and combinations thereof.

### RELATED APPLICATION

This is a utility of the provisional application of U.S. Application Ser. No. 62/553,260 entitled “Compositions of Micronutrients and Phytochemicals for Optimal Human Health.

### FIELD OF THE INVENTION

This invention relates to methods and formulations including phytonutrients from herbal sources, plant products or their derivatives, and other micronutrients including vitamins, minerals, dietary and endogenous antioxidants, glutathione-elevating agents, and other nutrients adapted for optimizing human health.

### BACKGROUND OF THE INVENTION

Humans utilize oxygen for survival but this process and the related normal metabolism generates free radicals that are potentially toxic by causing a condition known as oxidative stress. This oxidative damage may injure cells, tissues, organs and body proteins, lipids and DNA. Humans have developed an elaborate protective system consisting of antioxidants that directly quench free radicals and antioxidant enzymes that have specific functions. The enzyme superoxide dismutase requires trace minerals for its biological activity, is present in the cell nucleus, cytoplasm and mitochondria and removes free radicals. Another enzyme catalase requires iron for its biologic activity and addresses the aqueous cellular environment. Similarly, glutathione peroxidase requires selenium for its biological activity and can decrease hydrogen peroxide. The reduced form of nicotinamide adenine dehydrogenase also quenches free radicals.

Humans also produce other antioxidants or obtain them through the diet including glutathione, coenzyme Q10, alpha lipoic acid, vitamins A, C and E, carotenoids, phenolic compounds, other plant-based products and the mineral selenium.

Oxidative stress from excess free radicals is also generated by a diverse number of external factors affecting human health including air pollution, occupational exposures, physical activity, radiation (ionizing and electromagnetic radiofrequency), harsh environments, smoking, hazardous events (including deliberate acts of terrorism, weather catastrophes and military activities) and nuclear sources. While antioxidants are known protective agents, other cellular processes must also be considered as targets for therapeutic intervention since there is increasing recent recognition of the potential for hormones and natural substances to be beneficial (1-3). In addition, multiple inorganic and organic free radicals are derived from oxygen and nitrogen. Oxygen-derived free radicals include anions, oxy/hydroxyl free radicals, peroxy free radicals and organic free radicals. Nitrogen-derived free radicals include nitric oxide and peroxynitrite. Therefore, while injury may occur from many sources, the pathways of damage involve a few common mechanisms. This invention exploits the current information relative to the benefits of hormones, phytochemicals and additional micronutrients in reducing physical stressors while abrogating neuropsychological factors.

Different antioxidants generally have various mechanisms of action and a different affinity for each type of free radical, depending on the cellular environment. Some antioxidants are also particularly synergistic with each other. Therefore, utilizing only one or a limited number of antioxidants cannot be optimally effective. In fact, in high oxidative environments (pollution, hazardous occupations, toxic exposures, etc.), an individual antioxidant will readily become oxidized and act as a free radical and pro-oxidant, thereby increasing oxidative stress. However, in a multiple antioxidant formulation, single antioxidants are cycled back to a reduced form by the other micronutrients and do not impair the oxidation status.

In addition to excess free radicals, acute and chronic inflammatory reactions also contribute to the spectrum of injury. Reactive oxygen and nitrogen species and pro-inflammatory cytokines such as interleukin-6 and tumor necrosis factor-alpha, as well as adhesion molecules, complement proteins and prostaglandin E2 are released during these reactions. These released substances are very injurious to cells and organs. It is known that free radicals, reactive species, pro-inflammatory cytokines and the other molecules are major etiological factors in the initiation and/or progression of acute adverse health effects including chronic diseases and the complications that occur with them. For example, if free radicals damage dividing cells, the risk of mutations and carcinogenesis may increase. If they damage non-dividing cells such as neurons, it may result in neurological conditions. Oxidative damage has also been related to impaired immune function and the aging process. All of these factors may account for the long-standing recommendations to consume micronutrients especially as individuals become more elderly.

The proper source and chemical form of the antioxidant is important to insure a beneficial effect. In some instances, the natural form of the component (e.g. vitamin E and carotenoids) is more effective than the synthetic form. In other cases, both forms of the antioxidant (e.g. vitamin A and its precursor, beta-carotene) are not included even though they each have completely separate functions not provided by the other. In still other instances, the most biologically effective form of the antioxidant (e.g. alpha-tocopheryl succinate vs. alpha-tocopherol) was not employed. Finally, some studies used only dietary antioxidants and not endogenously made antioxidants or glutathione elevating agents, or utilized only micronutrient forms and did not include phytochemical or plant product-based antioxidants. These multiple factors may have contributed to the reason why many “controlled” intervention trials of antioxidants have produced inconsistent outcomes.

Current diets may be sufficient for growth and avoidance of minimal vitamin and mineral deficiencies, but supplemental micronutrients, including phytochemicals and antioxidants, are increasingly recognized as potentially important for optimal health. Even taking into account “ideal dietary food intake charts” studies suggest that most foods contain naturally occurring toxic as well as protective substances. The risk of illness may depend upon the relative consumption of protective versus toxic substances. Since levels of these substances in any diet may vary substantially, a daily supplement of micronutrients including antioxidants would be expected to enhance the level of preventive protection. Furthermore, high levels of mutagens and carcinogens are formed during digestion of food. The dietary habits of many individuals include low fiber intake and the resulting increased bowel emptying time may increase exposure to these toxins and could have adverse long-term health consequences. Studies suggest that oral intake of vitamin C and vitamin E reduces the formation of mutagens in the small intestine during normal digestion with the combination of the two being more effective than each antioxidant individually.

With this background, it is the intent of the current invention to overcome the limitations of previous supplement preparations. These complex formulations aim to maximize the potential beneficial health effects by combining a broad spectrum of micronutrients from multiple sources including phytochemical from plant herbals and their derivatives, vitamins, dietary and endogenous antioxidants, minerals and glutathione elevating agents. It was developed for broad human use from age four years and older to healthy young adults as well as to those individuals exposed to high risk environments (air pollution, occupational hazards, physical/psychological stress, toxic exposures, military personnel and combat veterans, radiation workers, survivors of weather/nuclear catastrophes/terrorism) and to elderly adults. The formulation is intended to reduce oxidative damage and inflammation while supporting the body's immune function and enhancing neuroprotection. Thereby, it may beneficially impact the initiation and/or progression of adverse human conditions such as those that affect the brain, eyes, hearing, heart, lungs, joints, metabolism as well as other body systems and processes.

### SUMMARY OF THE INVENTION

The present invention provides for a series of complex micronutrient formulations and combinations comprising vitamin A, vitamin B family, vitamin C, vitamin D, vitamin E, bergamot and related citrus polyphenols/flavonoids/rutin, cannabinoids, chokeberry, cinnamon, curcumin, flax seed with omega-3, 6 fatty acids, garlic, gensing, ginger, Ginkgo with rutin, grape juice/seed, calcium, carotenoids, chromium, magnesium, medium chain triglycerides, selenium, zinc, lutein, lycopene, melatonin, Moringa, resveratrol, spearmint species, spirulina, tea varieties, alpha-lipoic acid, co-enzyme Q-10, L-carnitine, L-cysteine and N-acetyl cysteine wherein said formulations are designed for supporting optimal health quality and protection against hazardous exposures or environments and adverse health conditions. The rationale for the multiple compositions, the dosing schedule and which ingredients are omitted is explained.

In one embodiment, the present invention provides for a formulation comprising at least one phytonutrient, at least one mineral, at least one dietary vitamin, at least one antioxidant, at least one glutathione-elevating agent, and at least one other nutrient, and mixtures and combinations thereof.

In another embodiment, the phytonutrient is selected from a group comprising of Bergamot, Cannabinoids, Chokeberry, Cinnamon, Curcumin, Flax seed, Garlic, Ginseng, Ginger, Ginkgo biloba, Grape juice, Moringa, Resveratrol, Spearmint, Spirulina, Tea, and mixtures and combinations thereof.

In yet another embodiment, the formulation has at least one hormone, and the hormone is melatonin. In still another embodiment, the mineral is selected from a group comprising Calcium, Choline, Chromium, Iodine, Magnesium, Selenium, Zinc, and mixtures and combinations thereof. In still yet another embodiment, the dietary vitamin is selected from a group comprising Vitamin B1, Vitamin B2, Vitamin B3, Vitamin B5, Vitamin B6, Vitamin B7, Vitamin B9, Vitamin B12, Vitamin D, and mixtures and combinations thereof.

In a further embodiment, the antioxidant is selected from a group comprising Vitamin A, Vitamin C, Vitamin E, Coenzyme Q10, Natural mixed carotenoids, and mixtures and combinations thereof. In another embodiment, the glutathione-elevating agent is selected from a group comprising Alpha-lipoic acid, L-cysteine, N-acetyl cysteine, and mixtures thereof. In another further embodiment, the nutrient is selected from a group comprising of Lutein, Lycopene, L-carnitine, and mixtures and combinations thereof.

In another embodiment, the formulation comprises a plurality of phytonutrients, said phytonutrients comprises of 1,000 mg of Bergmot, 200 mg of Cannabinoids, 20,000 mg Chokebery, 1,000 mg of Cinnamon, 500 mg of Curcummin, 100 mg of Flax Seed, 500 mg of Garlic, 500 mg of Ginseng, 500 mg of Ginger, 150 mg of Ginkgo biloba, 150 mg of Grape juice, 500 mg of Moringa, 250 mg of Resveratol, 450 mg of Spearmint, 500 mg of Spirulina, and 400 mg of Tea. In a further embodiment, the formulation is for humans age 14 and older.

In another further embodiment, the formulation comprises a plurality of phytonutrients, said phytonutrients comprises of 250 mg of Bergmot, 15 mg of Cannabinoids, 5,000 mg of Chokeberry, 100 mg of Cinnamon, 50 mg of Curcummin, 25 mg of Flax Seed, 50 mg of Garlic, 50 mg of Ginseng, 100 mg of Ginger, 10 mg of Ginkgo biloba, 50 mg of Grape juice, 100 mg of Moringa, 25 mg of Resveratol, 50 mg of Spearmint, 25 mg of Spirulina, and 100 mg of Tea. In yet a further embodiment, the formulation is for humans ages 4 to ages 13. In still a further embodiment, the hormone comprises of 0.5 to 2 mg of Melatonin.

In still yet a further embodiment, the formulation comprises a plurality of minerals, said minerals comprises of 250 mg of Calcium, 50 mcg of Chromium, 600 mg of Magnesium, 100 mcg of Selenium, and 10 mg of Zinc.

In another embodiment, the formulation comprises a plurality of minerals, said minerals comprises of 100 mg of Calcium, 250 mg of Choline, 15 mcg of Chromium, 100 mcg of Iodine, 50 mg of Magnesium, 30 mcg of Selenium, and 5 mg of Zinc.

In a further embodiment, the formulation comprises a plurality of dietary vitamins, said dietary vitamins comprises 3 mg of Vitamin B1, 4 mg of Vitamin B2, 20 mg of Vitamin B3, 8 mg of Vitamin B5, 4 mg of Vitamin B6, 100 mcg of Vitamin B7, 800 mcg of Vitamin B9, 8 mcg of Vitamin B12, and 600 IU of Vitamin D.

In another further embodiment, the formulation comprises a plurality of antioxidants, said antioxidants comprises 3,000 IU of Vitamin A, 500 mg Vitamin C, 300 IU of Vitamin E, 30 mg of Coenzyme Q10, and 15 mg of Natural mixed carotenoids. In yet another embodiment, the formulation comprises a plurality of glutathioine elevating agents, said glutathione elevating agents comprises 50 mg of Alpha-lipoic acid, 100 mg of L-cysteine, and 100 mg of N-acetylcysteine. In still another embodiment, the formulation comprises a plurality of other nutrients, said other nutrients comprises 20 mg Lutein, 15 mg Lycopene, and 100 mg of L-carnitine.

In another embodiment, the formulation comprising a plurality of dietary vitamins, said dietary vitamins comprises 1.5 mg of Vitamin B1, 1.6 mg of Vitamin B2, 12 mg of Vitamin B3, 5 mg of Vitamin B5, 2 mg of Vitamin B6, 50 mcg of Vitamin B7, 400 mcg of Vitamin B9, 4 mcg of Vitamin B12, and 400 IU of Vitamin D.

In still yet another embodiment, he formulation comprises a plurality of antioxidants, said antioxidants comprises 1, 200 IU of Vitamin A, 125 mg Vitamin C, 40 IU of Vitamin E, 10 mg of Coenzyme Q10, and 4 mg of Natural mixed carotenoids.

In another embodiment, the formulation comprises a plurality of glutathione elevating agents, said glutathione elevating agents comprises 20 mg of Alpha-lipoic acid, 12 mg of L-cysteine, and 12 mg of N-acetylcysteine.

In a further embodiment, the formulation comprises a plurality of other nutrients, said other nutrients comprises 5 mg Lutein, 3 mg Lycopene, and 50 mg of L-carnitine.

In another further embodiment, the formulation comprises of phytonutrients, minerals, dietary vitamins, antioxidants, glutathione elevating agents and other nutrients, and combinations thereof comprising:

Bergamot in a range from about 10 mg to about 3,000 mg

Cannabinoids in a range from about 2 mg to about 2,000 mg

Cinnamon in a range from about 25 mg to about 8,000 mg

Curcumin in a range from about 5 mg to about 5,000 mg

Flax seed in a range from about 1 mg to about 6,000 mg

Garlic in a range from about 5 mg to about 6,000 mg

Ginseng in a range from about 5 mg to about 4,000 mg

Ginger in a range from about 25 mg to 4,000 mg

Ginkgo biloba in a range from about 0.1 mg to about 2,000 mg

Grape juice in a range from about 10 mg to 500 mg

Moringa in a range from about 1 mg to about 4,000 mg

Resveratrol in a range from about 1 mg to about 2,000 mg

Spearmint in a range from about 1 mg to about 1200 mg

Spirulina in a range from about 0.1 mg to about 6,000 mg

Tea in a range from 25 mg to about 2,000 mg

Calcium in a range from about 10 mg to about 2,500 mg

Chokeberry in a range from about 50 mg to about 50,000 mg

Choline in a range from about 0 mg to about 500 mg

Chromium in a range from about 0.1 mcg to about 250 mcg

Iodine in a range from about 0 mcg to about 250 mcg

Lutein in a range from about 0.1 mg to about 200 mg

Lycopene in a range from about 0.1 mg to about 200 mg

Magnesium in a range from about 5 mg to about 1,250 mg

Medium Chain Triglyceride in a range from about 1 mg to about 30,000 mg

Natural mixed carotenoids in a range from about 0.1 mg to about 100 mg

Selenium in a range from about 0.5 mcg to about 300 mcg

Zinc in a range from about 0.1 mg to about 60 mg

Alpha-lipoic acid in a range from about 0.5 mg to about 300 mg

Coenzyme Q10 from about 0.1 mg to about 350 mg

L-carnitine in a range from about 1 mg to about 6,000 mg

L-cysteine in a range from about 0.1 mg to about 1,500 mg

N-acetylcysteine in a range from about 0.1 mg to 1,500 mg

Vitamin A from a range of about 100 IU to about 6,000 IU

B1 in a range from about 0.1 mg to about 5 mg

B2 in a range from about 0.1 mg to about 6 mg

B3 in a range from about 0.1 mg to about 100 mg

B5 in a range from about 0.1 mcg to about 20 mcg

B6 in a range from about 0.1 mg to about 50 mg

B7 in a range from about 5 mcg to about 500 mcg

B9 in a range from about 50 mcg to about 2,000 mcg

B12 in a range from about 0.1 mcg to about 50 mcg

Vitamin C in a range from about 30 mg to about 4,000 mg

Vitamin D in a range from about 50 IU to about 4,000 IU

Vitamin E in a range from about 2 IU to about 1,000 IU

and combinations thereof.

In a further embodiment, the Melatonin is in a range from about 0.1 mg to about 100 mg.

In yet a further embodiment, the present invention relates to a method of manufacturing a formulation, said method comprising admixing phytonutrients, minerals, dietary vitamins, antioxidants, glutathione elevating agents and other nutrient, and combinations thereof comprising:

Bergamot in a range from about 10 mg to about 3,000 mg

Cannabinoids in a range from about 2 mg to about 2,000 mg

Chokeberry in a range from about 50 mg to about 50,000 mg

Cinnamon in a range from about 25 mg to about 8,000 mg

Curcumin in a range from about 5 mg to about 5,000 mg

Flax seed in a range from about 1 mg to about 6,000 mg

Garlic in a range from about 5 mg to about 6,000 mg

Ginseng in a range from about 5 mg to about 4,000 mg

Ginger in a range from about 25 mg to 4,000 mg

Ginkgo biloba in a range from about 0.1 mg to about 2,000 mg

Grape juice in a range from about 10 mg to 500 mg

Moringa in a range from about 1 mg to about 4,000 mg

Resveratrol in a range from about 1 mg to about 2,000 mg

Spearmint in a range from about 1 mg to about 1200 mg

Spirulina in a range from about 0.1 mg to about 6,000 mg

Tea in a range from 25 mg to about 2,000 mg

Calcium in a range from about 10 mg to about 2,500 mg

Choline in a range from about 0 mg to about 500 mg

Chromium in a range from about 0.1 mcg to about 250 mcg

Iodine in a range from about 0 mcg to about 250 mcg

Lutein in a range from about 0.1 mg to about 200 mg

Lycopene in a range from about 0.1 mg to about 200 mg

Magnesium in a range from about 5 mg to about 1,250 mg

Medium Chain Triglyceride in a range from about 1 mg to about 30,000 mg

Natural mixed carotenoids in a range from about 0.1 mg to about 100 mg

Selenium in a range from about 0.5 mcg to about 300 mcg

Zinc in a range from about 0.1 mg to about 60 mg

Alpha-lipoic acid in a range from about 0.5 mg to about 300 mg

Coenzyme Q10 from about 0.1 mg to about 350 mg

L-carnitine in a range from about 1 mg to about 6,000 mg

L-cysteine in a range from about 0.1 mg to about 1,500 mg

N-acetylcysteine in a range from about 0.1 mg to 1,500 mg

Vitamin A from a range of about 100 IU to about 6,000 IU

B1 in a range from about 0.1 mg to about 5 mg

B2 in a range from about 0.1 mg to about 6 mg

B3 in a range from about 0.1 mg to about 100 mg

B5 in a range from about 0.1 mcg to about 20 mcg

B6 in a range from about 0.1 mg to about 50 mg

B7 in a range from about 5 mcg to about 500 mcg

B9 in a range from about 50 mcg to about 2,000 mcg

B12 in a range from about 0.1 mcg to about 50 mcg

Vitamin C in a range from about 30 mg to about 4,000 mg

Vitamin D in a range from about 50 IU to about 4,000 IU

Vitamin E in a range from about 2 IU to about 1,000 IU

and combinations thereof.

In still a further embodiment, the method of manufacturing admixing a hormone and said hormone is Melatonin in a range from about 0.1 mg to about 100 mg.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

The specific example below will enable the invention to be better understood. However, they are given merely by way of guidance and do not imply any limitation.

### Product Formulations by Risk Group and Age

This invention provides novel formulations that are derived from four entirely separate categories of ingredients:

a) Dietary Vitamins

b) Herbals, Plant Derivatives and Phytonutrients

c) Hormones, Minerals and Other Nutrients

d) Antioxidants and Glutathione Elevating Agents

The combinations included in the entire formula and within each category are further based on age and health risk. To provide another enhancement to the unique nature of this invention, different individuals may consume ingredient levels from the standard risk formulation in certain categories and from the high risk formulation of other categories. Consumption may also entail none of the ingredients from a particular category, all the ingredients in a category or partial combinations thereof. The doses listed are intended to be the complete daily dosage. For commercial application, this total dose will be divided in half into two equal servings (morning and evening) as will be explained in the subsequent sections

### Standard Risk Formulation, Ages 14 Years and Older, Consisting Essentially of:

| | |
|---|---|
| Primary Dose | Range |

Example 1: Dietary Vitamins
Vitamin B family

| | | | | |
|---|---|---|---|---|
| B1 (thiamine mononitrate or yeast sources) | 3 | mg | (0.1-4 | mg) |
| B2 (riboflavin or yeast sources) | 4 | mg | (0.1-5 | mg) |
| B3 (niacinamide ascorbate, nicotinic acid, nicotinamide or yeast sources) | 20 | mg | (10-30 | mg) |
| B5 (pantothenic acid, d-calcium pantothenate, rice bran, yeast or liver sources) | 8 | mg | (1-10 | mg) |
| B6 (pyridoxine hydrochloride or yeast sources) | 4 | mg | (0.1-6 | mg) |
| B7 (d-biotin or liver sources) | 100 | mcg | (50-200 | mcg) |
| B9 (folate, folic acid folacin, yeast or liver sources) | 800 | mcg | (200-1,000 | mcg) |
| B12 (cyanocobalamin, methylcobalamin or yeast sources) | 8 | mcg | (1-10 | mcg) |
| Vitamin D (as cholecalciferol-D3 or fish oils) | 600 | IU | (50-1,200 | IU) |

Example 2: Herbals, Plant Derivatives and Phytonutrients

| Bergamot (Citrus bergamia, plant, berry, leaf forms) | 1,000 | mg | (500-1,350 | mg) |
|---|---|---|---|---|
| Bergamot polyphenolic extract-BPE | 38% | | (30-47%) | |
| Cannabinoids (cannabidiol, hemp leaf, seeds, fiber, oil, protein, extract) | 200 | mg | (100-500 | mg) |
| Chokeberry (Aronia melanocarpa, whole fruit, berry) | 20,000 | mg | (10,000-30,000 | mg) |
| (juice concentrate, extracts) | 10,000 | mg | (5,000-15,000 | mg) |
| (powder, capsule forms) | 1,000 | mg | (500 mg-5,000 mg) | |
| Cinnamon (Cinnamomum species-e.g. cassia, zeylanicum, verum, | 1,000 | mg | (350-2,000 | mg) |
| osmophloeum; powder, bark, leaf, extract, oil) | | | | |
| Curcumin (turmeric root) | 500 | mg | (100-1,000 | mg) |
| Flax seed (extract, oil, or as omega-3, omega-6 fatty acid) | 100 | mg | (25-250 | mg) |
| Garlic (aged extract, oil, Allium species, cysteine derivatives | 500 | mg | (150-750 | mg) |
| Gensing (extract, Panax/Red Panax root of any origin including | 500 | mg | (100-750 | mg) |
| American, Siberian, Korean, Manchurian) | | | | |
| Ginger (gingerol, plant root sources, oil, powder) | 500 | mg | (50-2,000 | mg) |
| Gingko biloba, rutin (extract, leaf forms) | 150 | mg | (10-250 | mg) |
| Grape juice (polyphenols, extract) | 150 | mg | (25-250 | mg) |
| (as juice, 2 mg per ml) | 750 | mg | (200-1,000 | mg) |
| (as resveratrol mixture) | 250 | mg | (50-500 | mg) |
| Moringa (leaf extract-aqueous/alcoholic, powder, seeds, flower) | 500 | mg | (250-1,000 | mg) |
| Resveratrol (extract, fruit skin sources) | 250 | mg | (50-500 | mg) |
| Spearmint (leaves, oils, extracts) | 450 | mg | (100-600 | mg) |
| Spirulina (extract, blue-green algal sources) | 500 | mg | (100-1,000 | mg) |
| Tea, black, green (Camellia sinensis, extract, powders, leaf forms) | 400 | mg | (25-600 | mg) |

Example 3: Hormones, Minerals and Other Nutrients

| | | | | |
|---|---|---|---|---|
| Calcium (citrate, ascorbate, lactate or plant based sources) | 250 | mg | (100-1,200 | mg) |
| Chromium (picolinate, chromic chloride or natural forms) | 50 | mcg | (10-150 | mcg) |
| L-carnitine (fumarate or natural forms) | 100 | mg | (20-250 | mg) |
| Lutein (includes zeaxanthin) | 20 | mg | (1-30 | mg) |
| Lycopene (includes food sources) | 15 | mg | (1-25 | mg) |
| (as juice, tomato, etc.) | 150 | ml | (25-250 | ml) |
| Magnesium (citrate, lactate, gluconate, oxide, carbonate, hydroxide, chloride, sulphate, lactic | 600 | mg | (50-600 | mg) |
| acid, Jay phosphate, tribasic phosphate or natural forms) | | | | |
| Medium chain triglycerides (coconut/palm/MCT oil, capsule form) | 100 | mg | (100-10,000 | mg) |
| Melatonin (hormone, solid or liquid form) | 2 | mg | (0.1-5 | mg) |
| Selenium (L-selenomethionine, sodium selenite/selenite, natural forms) | 100 | mcg | (10-200 | mcg) |
| Zinc (glycinate, gluconate, oxide, sulphate or natural forms) | 10 | mg | (1-15 | mg) |

Example 4: Antioxidants and Glutathione Elevating Agents

| | | | | |
|---|---|---|---|---|
| Alpha-lipoic acid (R+, R−, yeast or liver sources) | 50 | mg | (5-100 | mg) |
| Coenzyme Q10 (ubiquinone, organ meat or natural ingredient sources-e.g. Agrobacterium | 30 | mg | (5-120 | mg) |
| tumefaciens, Paracoccus denitrificans, Pseudomonas aeruginosa) | | | | |
| L-cysteine (or natural food sources-e.g. soy extracts, sesame or flaxseeds, oat bran, | 100 | mg | (25-500 | mg) |
| wheat germ, Swiss cheese, peas or whole grain extracts) | | | | |
| N-acetylcysteine | 100 | mg | (25-500 | mg) |
| Natural mixed carotenoids (beta carotene, sea, algal or plant sources) | 15 | mg | (1-60 | mg) |
| Vitamin A (retinyl palmitate, fish oils or carotenoid sources) | 3,000 | IU | (1,500-4,000 | IU) |
| Vitamin C calcium ascorbate, citrus, rose or berry products | 500 | mg | (100-1,500 | mg) |
| Vitamin E (vegetable, wheat germ products or natural tocopherol) | | | | |
| (d-alpha tocopheryl succinate) | 200 | IU | (50-400 | IU) |
| (d-alpha tocopheryl acetate) | 100 | IU | (25-200 | IU) |

For individuals utilizing the “Standard Risk” formulation, it is intended that they consume:
a) at least four of the nine ingredients in the “Dietary Vitamins” category,
b) one to five of the sixteen ingredients in the “Herbals, Plant Derivatives and Phytonutrients” category,
c) at least three of the ten ingredients in the “Hormones, Minerals and Other Nutrients” category, and
d) at least one of the eight ingredients in the “Antioxidants and Glutathione Elevating Agents” category.

### High Risk Formulation, Ages 14 Years and Older, Consisting Essentially of:

| | |
|---|---|
| Primary Dose | Range |

Example 5: Dietary Vitamins
Vitamin B family

| | | | | |
|---|---|---|---|---|
| B1 (thiamine mononitrate or yeast sources) | 4 | mg | (4-5 | mg) |
| B2 (riboflavin or yeast sources) | 5 | mg | (5-6 | mg) |
| B3 (niacinamide ascorbate, nicotinic acid, nicotinamide or yeast sources) | 30 | mg | (30-100 | mg) |
| B5 (pantothenic acid, d-calcium pantothenate, rice bran, yeast or liver sources) | 10 | mg | (10-20 | mg) |
| B6 (pyridoxine hydrochloride or yeast sources) | 6 | mg | (6-50 | mg) |
| B7 (d-biotin or liver sources) | 200 | mcg | (200-500 | mcg) |
| B9 (folate, folic acid folacin, yeast or liver sources) | 1,000 | mcg | (1,000-2,000 | mcg) |
| B12 (cyanocobalamin, methylcobalamin or yeast sources) | 10 | mcg | (10-50 | mcg) |
| Vitamin D (as cholecalciferol-D3 or fish oils) | 1,200 | IU | (1,200-4,000 | IU) |

Example 6: Herbals, Plant Derivatives and Phytonutrients

| | | | | |
|---|---|---|---|---|
| Bergamot (Citrus bergamia, plant, berry, leaf forms) | 1,350 | mg | (1,350-3,000 | mg) |

| | | |
|---|---|---|
| Bergamot polyphenolic extract-BPE | 47% | (47-60%) |

| | | | | |
|---|---|---|---|---|
| Cannabinoids (cannabidiol, hemp leaf, seeds, fiber, oil, protein, extract) | 500 | mg | (500-2,000 | mg) |
| Chokeberry (Aronia melanocarpa, whole fruit, berry) | 30,000 | mg | (30,000-50,000 | mg) |
| (juice concentrate, extracts) | 15,000 | mg | (15,000-25,000 | mg) |
| (powder, capsule forms) | 5,000 | mg | (5,000-10,000 | mg) |
| Cinnamon (Cinnamomum species-e.g. cassia, zeylanicum, verum, | 2,000 | mg | (2,000-8,000 | mg) |
| osmophloeum; powder, bark, leaf, extract, oil) | | | | |
| Curcumin (turmeric root) | 1,000 | mg | (1,000-5,000 | mg) |
| Flax seed (extract, oil, or as omega-3, omega-6 fatty acid) | 250 | mg | (250-6,000 | mg) |
| Garlic (aged extract, oil, Allium species, cysteine derivatives | 750 | mg | (750-6,000 | mg) |
| Gensing (extract, Panax/Red Panax root of any origin including | 750 | mg | (750-4,000 | mg) |
| American, Siberian, Korean, Manchurian) | | | | |
| Ginger (gingerol, plant root sources, oil, powder) | 2,000 | mg | (2,000-4,000 | mg) |
| Gingko biloba, rutin (extract, leaf forms) | 250 | mg | (250-2,000 | mg) |
| Grape juice (polyphenols, extract) | 250 | mg | (250-500 | mg) |
| (as juice, 2 mg per ml) | 1,000 | mg | (1,000-2,000 | mg) |
| (as resveratrol mixture) | 500 | mg | (500-2,000 | mg) |
| Moringa (leaf extract-aqueous/alcoholic, powder, seeds, flower) | 1,500 | mg | (1,000-4,000 | mg) |
| Resveratrol (extract, fruit skin sources) | 500 | mg | (500-2,000 | mg) |
| Spearmint (leaves, oils, extracts) | 900 | mg | (600-1200 | mg) |
| Spirulina (extract, blue-green algal sources) | 1,000 | mg | (1,000-6,000 | mg) |
| Tea, black, green (Camellia sinensis, extract, powders, leaf forms) | 600 | mg | (600-2,000 | mg) |

Example 7: Hormones, Minerals and Other Nutrients

| | | | | |
|---|---|---|---|---|
| Calcium (citrate, ascorbate, lactate or plant based sources) | 1,200 | mg | (1,200-2,500 | mg) |
| Chromium (picolinate, chromic chloride or natural forms) | 150 | mcg | (150-250 | mcg) |
| L-carnitine (fumarate or natural forms) | 250 | mg | (250-6,000 | mg) |
| Lutein (includes zeaxanthin) | 30 | mg | (30-200 | mg) |
| Lycopene (includes food sources) | 25 | mg | (25-200 | mg) |
| (as juice, tomato, etc.) | 250 | ml | (250-400 | ml) |
| Magnesium (citrate, lactate, gluconate, oxide, carbonate, hydroxide, chloride, sulphate, lactic | 600 | mg | (600-1,250 | mg) |
| acid, Jay phosphate, tribasic phosphate or natural forms) | | | | |
| Medium chain triglycerides(coconut/palm/MCT oil, capsule form) | 10,000 | mg | (10,000-30,000 | mg) |
| Melatonin (hormone, solid or liquid form) | 5 | mg | (5-100 | mg) |
| Selenium (L-selenomethionine, sodium selenite/selenite, natural forms) | 200 | mcg | (200-300 | mcg) |
| Zinc (glycinate, gluconate, oxide, sulphate or natural forms) | 15 | mg | (15-60 | mg) |

Example 8: Antioxidants and Glutathione Elevating Agents

| | | | | |
|---|---|---|---|---|
| Alpha-lipoic acid (R+, R−, yeast or liver sources) | 100 | mg | (100-300 | mg) |
| Coenzyme Q10 (ubiquinone, organ meat or natural ingredient sources-e.g. Agrobacterium | 120 | mg | (120-350 | mg) |
| tumefaciens, Paracoccus denitrificans, Pseudomonas aeruginosa) | | | | |
| L-cysteine (or natural food sources-e.g. soy extracts, sesame or flaxseeds, oat bran, | 500 | mg | (500-1,500 | mg) |
| wheat germ, Swiss cheese, peas or whole grain extracts) | | | | |
| N-acetylcysteine | 500 | mg | (500-1,500 | mg) |
| Natural mixed carotenoids (beta carotene, sea, algal or plant sources) | 60 | mg | (60-100 | mg) |
| Vitamin A (retinyl palmitate, fish oils or natural mixed carotenoids) | 5,000 | IU | (4,000-6,000 | IU) |
| Vitamin C (calcium ascorbate, citrus, rose or berry products) | 1,500 | mg | (1,500-4,000 | mg) |
| Vitamin E (vegetable, wheat germ products or natural tocopherol) | | | | |
| (d-alpha tocopheryl succinate) | 400 | IU | (400-600 | IU) |
| (d-alpha tocopheryl acetate) | 200 | IU | (200-400 | IU) |

For individuals utilizing the “High Risk” formulation, it is intended that they consume:
a) at least six of the nine ingredients in the “Dietary Vitamins” category,
b) at least five of the sixteen ingredients in the “Herbals, Plant Derivatives and Phytonutrients” category,
c) at least five of the ten ingredients in the “Hormones, Minerals and Other Nutrients” category, and
d) at least two of the eight ingredients in the “Antioxidants and Glutathione Elevating Agents” category.

### Youth Formulation, Ages 4-13 Years, Consisting Essentially of:

| | |
|---|---|
| Primary | |
| Dose | Range |

Example 9: Dietary Vitamins
Vitamin B family

| | | | | |
|---|---|---|---|---|
| B1 (thiamine mononitrate or yeast sources) | 1.5 | mg | (0.1-2 | mg) |
| B2 (riboflavin or yeast sources) | 1.6 | mg | (0.1-2 | mg) |
| B3 (niacinamide ascorbate, nicotinic acid, nicotinamide or yeast sources) | 12 | mg | (0.1-15 | mg) |
| B5 (pantothenic acid, d-calcium pantothenate, rice bran, yeast or liver sources) | 5 | mg | (0.1-5 | mg) |
| B6 (pyridoxine hydrochloride or yeast sources) | 2 | mg | (0.1-4 | mg) |
| B7 (d-biotin or liver sources) | 50 | mcg | (5-100 | mcg) |
| B9 (folate, folic acid folacin, yeast or liver sources) | 400 | mcg | (50-800 | mcg) |
| B12 (cyanocobalamin, methylcobalamin or yeast sources) | 4 | mcg | (0.1-6 | mcg) |
| Vitamin D (as cholecalciferol-D3 or fish oils) | 400 | IU | (50-500 | IU) |

Example 10: Herbals, Plant Derivatives and Phytonutrients

| Bergamot (Citrus bergamia, plant, berry, leaf forms) | 250 | mg | (10-500 | mg) |
|---|---|---|---|---|
| Bergamot polyphenolic extract-BPE | 30% | | (10-30%) | |
| Cannabinoids (cannabidiol, hemp leaf, seeds, fiber, oil, protein, extract) | 15 | mg | (2-100 | mg) |
| Cinnamon (Cinnamomumspecies-e.g. cassia, zeylanicum, verum, | 100 | mg | (25-350 | mg) |
| osmophloeum; powder, bark, leaf, extract, oil) | | | | |
| Chokeberry (Aronia melanocarpa, whole fruit, berry) | 5,000 | mg | (1,000-10,000 | mg) |
| (juice concentrate, extracts) | 2,000 | mg | (500-5,000 | mg) |
| (powder, capsule forms) | 300 | mg | (50-500 | mg) |
| Curcumin (turmeric root) | 50 | mg | (5-100 | mg) |
| Flax seed (extract, oil, or as omega-3, omega-6 fatty acid) | 25 | mg | (1-50 | mg) |
| Garlic (aged extract, oil, Allium species, cysteine derivatives) | 50 | mg | (5-150 | mg) |
| Gensing (extract, Panax/Red Panax root of any origin including | 50 | mg | (5-100 | mg) |
| American, Siberian, Korean, Manchurian) | | | | |
| Ginger (gingerol, plant root sources, oil, powder) | 100 | mg | (25-200 | mg) |
| Gingko biloba, rutin (extract, leaf forms) | 10 | mg | (0.1-50 | mg) |
| Grape juice (polyphenols, extract) | 50 | mg | (10-100 | mg) |
| (as juice, 2 mg per ml) | 250 | mg | (50-500 | mg) |
| (as resveratrol mixture) | 25 | mg | (1-100 | mg) |
| Moringa (leaf extract-aqueous/alcoholic, powder, seeds, flower) | 100 | mg | (1-250 | mg) |
| Resveratrol (extract, fruit skin sources) | 25 | mg | (1-100 | mg) |
| Spearmint (leaves, oils, extracts) | 50 | mg | (1-100 | mg) |
| Spirulina (extract, blue-green algal sources) | 25 | mg | (0.1-100 | mg) |
| Tea, black, green (Camellia sinensis, extract, powders, leaf forms) | 100 | mg | (25-200 | mg) |

Example 11: Hormones, Minerals and Other Nutrients

| | | | | |
|---|---|---|---|---|
| Calcium (citrate, ascorbate, lactate or plant based sources) | 100 | mg | (10-200 | mg) |
| Choline (bitartrate, soy, vegetable or natural sources) | 250 | mg | (5-500 | mg) |
| Chromium (picolinate, chromic chloride or natural forms) | 15 | mcg | (0.1-30 | mcg) |
| Iodine (potassium iodide, Lugol's solution, kelp or natural sources) | 100 | mcg | (1-250 | mcg) |
| L-carnitine (fumarate or natural forms) | 50 | mg | (1-100 | mg) |
| Lutein (includes zeaxanthin) | 5 | mg | (0.1-20 | mg) |
| Lycopene (includes food sources) | 3 | mg | (0.1-15 | mg) |
| (as juice, tomato, etc.) | 90 | ml | (30-150 | ml) |
| Magnesium (citrate, lactate, gluconate, oxide, carbonate, hydroxide, chloride, sulphate, lactic | 50 | mg | (5-250 | mg) |
| acid, Jay phosphate, tribasic phosphate or natural forms) | | | | |
| Medium chain triglycerides (coconut/palm/MCT oil, capsule form) | 10 | mg | (1-100 | mg) |
| Melatonin (hormone, solid or liquid form) | 0.5 | mg | (0.1-2 | mg) |
| Selenium (L-selenomethionine, sodium selenite/selenite, natural forms) | 30 | mcg | (0.5-75 | mcg) |
| Zinc (glycinate, gluconate, oxide, sulphate or natural forms) | 5 | mg | (0.1-15 | mg) |

Example 12: Antioxidants and Glutathione Elevating Agents

| | | | | |
|---|---|---|---|---|
| Alpha-lipoic acid (R+, R−, yeast or liver sources) | 20 | mg | (0.5-50 | mg) |
| Coenzyme Q10 (ubiquinone, organ meat or natural ingredient sources-e.g. Agrobacterium | 10 | mg | (0.1-30 | mg) |
| tumefaciens, Paracoccus denitrificans, Pseudomonas aeruginosa) | | | | |
| L-cysteine (or natural food sources-e.g. soy extracts, sesame or flaxseeds, oat bran, | 12 | mg | (0.1-100 | mg) |
| wheat germ, Swiss cheese, peas or whole grain extracts) | | | | |
| N-acetylcysteine | 12 | mg | (0.1-100 | mg) |
| Natural mixed carotenoids (beta carotene, sea, algal or plant sources) | 4 | mg | (0.1-15 | mg) |
| Vitamin A (retinyl palmitate, fish oils or natural mixed carotenoids) | 1,200 | IU | (100-1,500 | IU) |
| Vitamin C (calcium ascorbate, citrus, rose or berry products) | 125 | mg | (30-250 | mg) |
| Vitamin E (vegetable, wheat germ products or natural tocopherol) | | | | |
| (d-alpha tocopheryl succinate) | 20 | IU | (1-50 | IU) |
| (d-alpha tocopheryl acetate) | 20 | IU | (1-25 | IU) |

For individuals utilizing the “Youth” formulation, it is intended that they consume:
a) at least four of the nine ingredients in the “Dietary Vitamins” category,
b) at least one of the sixteen ingredients in the “Herbals, Plant Derivatives and Phytonutrients” category,
c) at least three of the twelve ingredients in the “Hormones, Minerals and Other Nutrients” category, and
d) at least one of the eight ingredients in the “Antioxidants and Glutathione Elevating Agents” category.

### Methods of the Invention

In one embodiment of the present invention, the methods of this invention also take into account the unique pharmacokinetics of micronutrient substances. The biological half-life of the water-soluble constituents is generally about six hours, while that of the lipid-soluble components is approximately eight to twelve hours. The typical once-a-day administration of micronutrients would cause an early “peak” serum level soon after consumption and a deep “trough” level about eight or more hours later. This trough level induces physiologic changes that may translate into “stress” signals throughout the body and is counterproductive to the goal of this combination of micronutrient supplementation.

Therefore, administration of the current micronutrient formulations is recommended to be twice a day approximately twelve hours apart (ideally before or with the morning and evening meals). This dosing schedule is necessary to ensure that consistently even and adequate levels of components are present in the body's tissues. In a preferred manner of administration, the non-plant-based micronutrients as well as the phytonutrient ingredients are each separately packaged into four to six #0 or #00 size capsules, which comprise a typical complete daily dosage. To accommodate the pharmacokinetic aims described previously, the total dosage will be split in half. Therefore, each set of two or three capsules (non-plant and phytonutrient) will be consumed half in the morning and half in the evening. For the alternative methods of product delivery (not capsules) as listed in the “Impact of the Invention” section below, it is intended that the twice a day dosing schedule of half in the morning and half in the evening will be maintained.

### Category and Ingredient Rationale

This section will discuss the scientific rationale for the use of several components of this invention in some of the major ingredient categories. The preferred dosing schedule and method of delivery is outlined. An explanation is also provided for those micronutrient substances that are specifically omitted.

### Dietary Vitamins and Antioxidants:

Vitamin C prevents lipid oxidation and potentiates nitric oxide activity in normalizing vascular function in patients with cardiovascular disease associated with high blood pressure, high cholesterol levels and in smokers. Vitamin C is necessary to protect cellular components in aqueous environments and plays an important role in maintaining cellular levels of vitamin E by recycling the vitamin E radical (oxidized) to the reduced (antioxidant) form. Recent studies have elucidated the metabolic and genetic cellular mechanisms in hematopoietic stem cells. Mutations in these cells can lead to blood cancers and vitamin C appears to restore normal cellular regulation and may reduce canter risk and suppress cancer progression (9, 10). Vitamin C as calcium ascorbate is beneficial because it is the most effective non-acidic form available for human use and, therefore, is less likely to cause stomach upset, diarrhea, and other issues that are observed in some individuals consuming the ascorbic acid form of the vitamin. The combination of vitamins C and E produces a synergistic inhibition on LDL-cholesterol oxidation.

In addition to being a robust antioxidant, vitamin E reduces oxidation of membrane and LDL cholesterol, reduces c-myc activated pathways responsible for smooth muscle cell proliferation and reduces aggregation of platelets. The proper form, ratio and type of vitamin E are important to maximize the reduction of oxidative damage. Not all forms of the vitamin are easily soluble and can enter cells. Human tissues selectively absorb the natural form of vitamin E, d-alpha tocopherol, which acts in the intestinal tract and in the extracellular space. It stimulates the immune system whereas other forms of tocopherol (e.g. beta, gamma, delta) do not. The d-alpha tocopheryl succinate form of vitamin E is the most effective natural form of this micronutrient to maintain internal cellular components and it also actively reduces the incidence of radiation-induced transformation in mammalian cells. This form of vitamin E is a more effective antioxidant than the alpha tocopherol or other mixtures of tocopherols. Since both forms are necessary, an equal ratio or up to a 3:1 ratio (favoring the succinate form) provides optimal vitamin E function. Tocotrienols also have antioxidant effects, but they may inhibit cholesterol synthesis and are omitted from this formulation.

Vitamin A and its precursor, beta-carotene, are also essential antioxidants that decrease excess free radical-induced oxidative stress. These two agents must be included individually because they each possess specific biological functions not provided by the other. Vitamin A is critical for induction of beneficial cellular differentiation while beta-carotene increases the expression of the connexin gene, which encodes for a gap junction protein that is necessary in maintaining normal cellular phenotypes. It is also more effective in quenching oxygen-derived free radicals. Both of these antioxidants protect cellular components in lipid environments. The natural “trans” isoform of vitamin A is biologically active and only the natural form of beta-carotene can effectively decrease radiation-induced cellular abnormalities.

Other dietary carotenoids are equally important. Similar protection against oxidative stress and radiation is noted in vitro with use of lycopene, a potent antioxidant in tomato juice. This compound also reduces oxidative damage related to physical activity. In addition, it protects against neurotoxicity and provides biochemical stabilization in brain injury models. Lutein is another dietary carotenoid that demonstrates antioxidant properties in humans with related health benefits. It functions as a strong antioxidant in vivo and reduces oxidative stress in individuals with low antioxidant status subjected to hostile environments. This substance has a unique characteristic in that it can induce increases in physical activity in sedentary persons and is also neuroprotective against transient brain ischemia.

Multiple antioxidants are virtually always more effective than the individual agents themselves. For example, a combination of antioxidants is more effective in tumor cell growth inhibition than any of the individual agents utilized. Vitamin C and vitamin E are synergistic as antioxidants against free radicals because they are able to protect both the aqueous and lipid environments of the cells respectively. In fact, these antioxidant vitamins and beta-carotene have been shown to be effective radio-protectants. Additional antioxidant combinations can protect against ischemia and reperfusion injury. It is also recognized that oxygen level may vary widely within the organs, tissues and individual cells. This is especially true during the biological damage related to the many adverse health factors addressed by this invention. It is known that vitamin A and beta-carotene act more effectively as antioxidants in high oxygen environments, whereas vitamin E is a more effective antioxidant at reduced oxygen pressures.

### Phytonutrients, Herbals and Plant-Based Derivatives:

The health benefits of the bergamot plant and other citrus fruits present a broad spectrum of effects including not only as antioxidants but also as modulators of enzymes, receptors, genes and cell signaling pathways. These activities are related to the particularly high content of polyphenols, flavonoids and other bioactive compounds such as rutin within bergamot species. The plant's polyphenolic fraction has been characterized and imparts cardio-metabolic benefits in human studies. Citrus flavonoids also demonstrate mechanisms to provide anti-inflammatory and neuroprotective properties.

The hemp plant is one of the two major varieties of Cannabis sativa and must be distinguished from marijuana, the other major form. Hemp contains a significant amount of the phytocannabinoid, cannabidiol (CBD) which is not psychoactive (like marijuana), is safe for human consumption and demonstrates potentially beneficial health effects. Hemp oils, proteins and extracts from the plant leaves, seeds or fibers provide CBD-rich product concentrations that can be processed into nutritional consumables for oral (solid or liquid) ingestion, smoking (or vaping) inhalation, topical absorption or even parenteral (injectable) applications.

CBD has demonstrated properties in animal models and human trials relative to neurological factors such anxiety, pain, emotion, behavior as well as psychotic and inflammatory conditions. Cannabinoid pathways appear to have an important association with depression, stress disorders and related pain syndromes which represent potential avenues for therapeutic strategies. In fact, recent human clinical trials have provided compelling evidence of beneficial results with orally ingested CBD alone in social anxiety disorders.

In a similar manner as with the bergamot plant, the chokeberry shrub also contains a variety of polyphenol constituents, anthocyanins and procyanidins that account for the many beneficial biological effects that can be demonstrated in the laboratory as well as in vivo and in human trials. This well-characterized phytonutrient has been compared to many other fruit plants and has been found to contain among the highest levels of phenolic content and antioxidant activity. Further research has shown that Aronia fruit extracts may protect vascular endothelial cells from oxidative stress-related dysfunction thereby potentially diminishing the progression of coronary artery disease. In addition, many fruit extracts are known to inhibit the growth of cancer cells. However, Aronia's activity has demonstrated among the strongest effects in this regard. Finally, chokeberry juice may provide a potent anti-diabetic effect in relation to reduction in weight and blood glucose levels.

The Cinnamomum genus contains a large number of species of cinnamon tree and provides one of the most common globally available spices. The constituents derived from cinnamon have been associated with an extensive array of health-related properties including antioxidant, anti-inflammatory, neuroprotective, antidiabetic and cardio-metabolic.

The importance of intracellular glutathione as an antioxidant is well known and its defense of the immune system as well as relevance to neurologic pathophysiology is being increasingly recognized. The potent antioxidant and anti-inflammatory activity of cinnamon in this regard has been documented by studies in experimental systems. In addition, the neuroprotective capacity of the spice and its derivatives has been demonstrated in conditions such as Alzheimer's and Parkinson's diseases utilizing both in vitro and in vivo models.

Cinnamon has also shown beneficial health effects in cardio-metabolic risk, lipid levels, vascular reactivity and pancreatic beta cell protection in diabetic animal models and human trials. Finally, positive effects from cinnamon were detected in animals and humans including improvement in physical performance, decrease in muscle soreness and protection against ischemic neurological injury.

Curcumin is a phytonutrient abundantly present in the spice, turmeric, and demonstrates a wide spectrum of therapeutic properties. Its potential application to lung protection from hazardous occupational and environmental exposures has been described. This polyphenolic agent decreases muscular pain and reduces inflammation and post-exercise muscle damage in human subjects. It improves in vivo neural functioning and protects against oxidative stress and brain ischemia-reperfusion injury. Curcumin has also shown benefit against oxidative damage, and in combination with resveratrol, demonstrates unique radioprotective qualities on normal tissues.

Flax seed and its oils are excellent sources of omega-3 and omega-6 fatty acids, and these substances have demonstrated positive health effects in animal models and in human clinical conditions. They have also shown benefit in vivo against ultraviolet radiation-induced oxidative stress. The omega fatty acid constituents decrease inflammation biomarkers, muscle soreness and blood pressure after exercise. Recent studies demonstrate that this potent anti-inflammatory effect on the immune and nervous systems is mediated through endocannabinoids. It is of interest because the present invention also separately includes cannabidiol (CBD) in the formulation so the beneficial effects could be synergistic. Furthermore, In vivo and human studies show neurological effects from the flax seed fatty acids such as enhanced brain development and improved spatial memory.

Garlic contains organo-sulphur compounds that function as effective antioxidant phytonutients and reduce cellular oxidative stress by scavenging free radicals and enhancing antioxidant enzyme systems. The cysteine derivatives in garlic reduce inflammation and muscle soreness after physical activity in athletes. The health effects are demonstrated against a variety of hazards such as pollutants and radiation exposure. The substance is also neuroprotective and inhibits oxidative stress and improves neurological deficits in brain ischemia in animal models.

Ginseng is a natural product that has a long history of safe human use. Many beneficial health functions including robust antioxidant and radioprotective capacity have been documented in a number of vivo and in human studies. This herbal plant and its phytonutrients improve exercise performance, protect against muscle damage and prevent vascular abnormalities after exercise. They also provide unique anti-inflammatory and immune-stimulatory neuroprotective effects.

The ginger plant has known anti-inflammatory effects and in human trials has been shown to reduce muscle discomfort associated with physical activity. Ginger contains the powerful phenol, gingerol, and the active chemical, zingerone that are responsible for a portion of its strong effect. Essential oils or extracts of this phytonutient have shown radioprotective properties. In fact, this agent can produce decreases in inflammation biomarkers and muscle soreness in both male and female subjects. Ginger also exhibits a neuroprotective in vivo effect by enhancing the antioxidant defense mechanisms in the brain.

Ginkgo biloba has been consumed for health benefits in humans for centuries. The positive effects of the extract on oxidative stress and radiation injury have been shown in vivo and in humans recovering from the Chernobyl nuclear accident. The extract also may protect against radiofrequency radiation such as experienced with mobile phone usage. The leaf of the Ginkgo plant contains the citrus flavonoid pigment rutin. This compound and its extracts have demonstrated in vivo protection against ionizing radiation and oxidative damage in disease models. In addition, these compounds reduce oxidative stress related to exertion and act as neuroprotectants by decreasing the biochemical abnormalities due to ischemia-reperfusion injury in the brain.

Grape seeds and extracts thereof protect against ultraviolet radiation via their phenolic compounds, the proanthocyanidins. Grape juice polyphenols and resveratrol improve antioxidant capacity and diminish oxidative stress. These compounds protect neurocognitive function in older adults and spatial memory and performance in younger adults. Resveratrol is a polyphenolic compound derived from the skin of grapes and other berries and is also neuroprotective as a single agent. It has importance in environmental exposure as shown by its protective effect against the oxidative stress caused by cigarette smoke. In addition, there are number of studies that document its protective antioxidant effect against radiation damage.

A widely utilized edible plant, Moringa oleifera, has provided beneficial human nutritional supplementation in a variety of forms including leaves, seeds, flowers, roots, oils, bark, sap, gum and pods. Whole plant forms or aqueous and ethanol extracts of this phytonutrient have been prepared with multiple modes of delivery usually by oral consumption of teas, powders or tablets. Administration of whole plant forms has been shown to be safe in animal studies up to doses of 2000 mg/kg, and in human trials up to doses of 500 mg/kg. Extracts show no in vivo toxicity in doses up to 100 mg/kg.

In vitro and animal studies have shown protective biological activity of Moringa as an antioxidant, anti-lipidemic, antidiabetic and anti-inflammatory agent. The plant also has demonstrated gastrointestinal and hepatoprotective characteristics in experimental models. Of further interest are the neuroprotective qualities of this nutrient in terms of cerebral ischemia, memory impairment and anxiety disorders. Moringa has also been shown to have significant in vitro anti-cancer effects. Human studies have confirmed antioxidant, anti-hyperglycemic and anti-lipidemic properties without any toxicity.

The mint (genus Mentha) plant of the Lamiaceae family is well known to contain many active phytochemicals. Among the species of mint, the spearmint (Mentha spicata L.) exhibits a variety of important and potential clinically relevant properties because of its broad component profile. This includes active polyphenolic compounds such as rosmarinic acid, salvionolic acid, caftaric acid and lithospermic acid. Spearmint leaves, oils and aqueous and phenolic extracts have demonstrated a robust safety record in experimental and in vivo studies. Indeed, these derivatives of the plant have been granted Generally Recognized As Safe (GRAS) status in the United States.

The polyphenols in spearmint have demonstrated diverse biological activity in animal and human trials. In vitro studies have shown broad antioxidant properties. These findings were confirmed in animal models. In vivo studies have also been utilized to demonstrate anti-apoptotic activity and benefit to neuronal cell health. Of particular clinical potential is the neurogenic and neuroprotective qualities of spearmint polyphenols. Specific studies of neurological disease models show important findings. For example, protection of memory in amyloid peptide-induced Alzheimer's models has been demonstrated. Likewise, similar neuroprotection in models of Parkinson's disease has been shown. In addition, spearmint compounds provide beneficial effects in brain function, oxidative damage and inflammation in murine models (166, 175). Finally, a human clinical trial has confirmed in vivo findings in relation to improvement in cognitive function.

Spirulina is a blue-green algae and a species of cyanobacteria. Because it contains many ingredients, it may function as an anti-inflammatory, antioxidant, anti-angiogenic and immunomodulatory agent. There are extensive reports relative to the positive in vitro and in vivo findings as well as its human health benefits. When the natural form of the compound is entirely pure and not contaminated, it has been shown to be safe for human consumption. Spirulina also has important beneficial qualities in human exercise studies. This alga reduces muscle strain, enhances exercise performance, attenuates oxidative damage and improves physical and mental fatigue. In addition, it can provide a broad spectrum of protective effects in neurodegenerative conditions.

Green and black tea beverages show strong antioxidant effects in human trials and in vitro protection against radiation exposure. It has also been suggested that green tea in combination with Ginkgo biloba may provide substantial photoprotection. Extracts of black and green tea, including the compound theanine, have neuroprotective qualities. These components prevent memory impairment and improve cognitive function in humans of varying age as well as showing promising effects in psychiatric and neurodegenerative disorders.

It is known that some phytonutrients have potential for adverse health effects including oxidative stress, liver toxicity, increased bleeding risk (individuals taking blood thinners) and interference with some prescription medications. The incidence of risk for the phytonutrients utilized in this invention are rare and usually noted in association with uncontrolled consumption or contamination with microbials, mycotoxins or heavy metals, and not as a causative agent of the observed health effect. Nevertheless, whenever these ingredients are included in a formulation, appropriate information or statement for referral to a health care professional for product approval will be provided.

### Hormones, Minerals and Other Nutrients:

Medium chain triglycerides (MCTs) consist of fatty acids with a 6-12 aliphatic carbon atom chain. This specific group of four predominant fatty acids is directly metabolized to ketone bodies that provide alternative cellular energy sources especially to neurons. They are naturally sourced from coconut and palm oils and more effectively ketogenic than longer chain triglycerides. Therefore, the interest in diets utilizing this biologic mechanism has flourished dramatically and the term “ketonomics” has been ascribed to the underlying science. MCT-containing oils can improve liver and cardiovascular function in obesity-related metabolic syndrome in vivo. These compounds may also experimentally provide reduction in harmful inflammatory responses. Increasing research has suggested possible beneficial effects of MCTs in neurological conditions such as dementias, seizure disorders and migraine headaches. There is also recent evidence of an anti-cancer effect from MCT-supplemented diets in mice. In addition, these triglycerides may reduce food intake through thermogenesis and positively impact obese subjects.

The pineal gland hormone, melatonin, is another antioxidant that has demonstrated protective qualities against hazardous exposures in laboratory, in vivo and in clinical studies. It can improve exercise tolerance, energy and performance. The hormone effectively crosses the blood-brain barrier, increases brain antioxidants and decreases swelling, inflammation and pressure in concussive head injury models.

Selenium is a co-factor of glutathione peroxidase, and Se-glutathione peroxidase also acts as an antioxidant. This mineral also decreases harmful effects of pro-inflammatory cytokines and is radio-protective. Therefore, selenium supplementation at adequate but safe doses is essential for promoting antioxidant enzyme systems and reducing potential oxidative stress.

Iron, copper and manganese are also essential for the activities of antioxidant enzymes. However, it is well known that these substances actively generate excess free radicals when combined with vitamin C through the Fenton reaction. This pro-oxidative state enhances cell injury and is the opposite of the desired goals of this invention. In addition, these minerals are more easily absorbed from the intestinal tract in the presence of antioxidants, and thereby, increase the body stores of these minerals. Excess free iron, copper and manganese have been associated with chronic human conditions including heart disease, cancer, and neurological diseases. Therefore, this invention omits these specific potentially harmful minerals.

Heavy metals such as boron, molybdenum, vanadium, and zirconium are common supplement constituents but sufficient amounts are obtained from the diet. Daily consumption of excess amounts of these metals over long periods of time have been reported to have neurotoxic potential in humans so they are also omitted from the formulation.

### Antioxidants and Glutathione Elevating Agents:

Glutathione, a sulfhydryl compound, is the body's primary endogenously formed antioxidant. It can catabolize anions and hydrogen peroxide and is a potent intracellular protective agent against excess free radical damage. In addition, reduced glutathione actively protects both normal and cancer cells against radiation damage. Specifically, sulfhydryl compounds protect against radiation injury to the bone marrow and gastrointestinal system as well as against cellular mutagenesis and can induce radiation resistance. However, when glutathione is consumed orally by humans, its plasma levels do not significantly increase suggesting that this tripeptide is completely hydrolyzed in the intestinal tract during digestion.

Nevertheless, two other agents, N-acetylcysteine and alpha lipoic acid, have been shown to actively increase intracellular glutathione levels by different non-competing mechanisms. They are well tolerated in humans, are rapidly absorbed without toxicity and have demonstrated radio-protective value. This further confirms their antioxidant value since it is estimated that the majority of the cellular damage from radiation is due to excess free radicals. These agents also restore glutathione in endothelial cells and cardiac muscle that suffered oxidative damage with resultant beneficial effects. Alpha-lipoic acid also has some unique functions in relation to metabolic disorders. It improves glucose utilization in peripheral tissue by stimulating glucose transport and uptake, thereby diminishing insulin resistance and decreases related complications by reducing protein glycation and oxidative stress.

Only the natural “L” form of (acetyl-, proprionyl-) L-carnitine is biologically active in humans. This agent is included in the invention because of its role in energy production, beneficial circulatory effects and neuroprotective qualities. It is safe and well-tolerated for extended time periods and the crosses the blood brain barrier. Various forms have demonstrated positive clinical benefits in vascular and neurodegenerative conditions. It can also protect against radiation-induced sensory organ and brain damage. In addition, L-carnitine and alpha lipoic acid synergistically enhance mitochondrial function.

Although coenzyme Q10 has only modest antioxidant activity, it acts as a co-factor for generating adenosine-5′-triphosphate (ATP) during Kreb's cycle metabolism in the mitochondria. This is particularly important in middle age and beyond where improvement in mitochondrial function can result in improved energy levels and quality of life. Coenzyme Q10 also protects against neurological abnormalities. Finally, this compound scavenges peroxy radicals faster than alpha-tocopherol and, like vitamin C, can regenerate vitamin E in a redox cycle.

### IMPACT OF THE INVENTION

Research demonstrates that less than ten percent of oral micronutrients are fully absorbed. Thus, the dosages and dose ranges must have wide applicability. It appears more rationale to utilize a “target” of formulation categories that contains the basic micronutrients for optimal health and then blend the combinations of ingredients based on individual risk factors and age. In this invention, the primary dosing and ranges are designed to be at adequately broad and sufficient levels to have the desired beneficial effects in humans of both genders and of wide age and weight cohorts. The basic classes of micronutrients to which the components of the present formulations belong is known to reduce oxidative damage and inflammation, support immune system function and neuroprotection and enhance optimal health.

While the product platform describes oral capsules, this invention is intended to also relate to any form of administration of these formulations in humans including but not limited to tablets, bars, liquids, powders, gummies, lozenges/troches, dissolvable disks, chewables, inhalational forms, injectables, patches, ointments, gels, aerosols and sticks as well as any transcutaneous, intranasal, intra-cavitary, liposomal, nanotechnology or other delivery system.

Numerous modifications and variations of the present invention are possible in light of the above teachings. It is therefore to be understood that within the scope of the attendant claims.

What is claimed is:

1. A formulation comprising at least one phytonutrient, at least one mineral, at least one dietary vitamin, at least one antioxidant, at least one glutathione-elevating agent, and at least one other nutrient, and mixtures and combinations thereof.

2. The formulation of claim 1 wherein said phytonutrient is selected from a group comprising of Bergamot, Cannabinoids, Chokeberry, Cinnamon, Curcumin, Flax seed, Garlic, Ginseng, Ginger, Ginkgo biloba, Grape juice, Moringa, Resveratrol, Spearmint, Spirulina, Tea, and mixtures and combinations thereof.

3. The formulation of claim 1 having at least one hormone, wherein said hormone is melatonin.

4. The formulation of claim 1 wherein said mineral is selected from a group comprising Calcium, Choline, Chromium, Iodine, Magnesium, Selenium, Zinc, and mixtures and combinations thereof.

5. The formulation of claim 1 wherein said dietary vitamin is selected from a group comprising Vitamin B1, Vitamin B2, Vitamin B3, Vitamin B5, Vitamin B6, Vitamin B7, Vitamin B9, Vitamin B12, Vitamin D, and mixtures and combinations thereof.

6. The formulation of claim 1 wherein said antioxidant is selected from a group comprising Vitamin A, Vitamin C, Vitamin E, Coenzyme Q10, Natural mixed carotenoids, and mixtures and combinations thereof.

7. The formulation of claim 1 wherein said glutathione-elevating agent is selected from a group comprising Alpha-lipoic acid, L-cysteine, N-acetyl cysteine, and mixtures thereof.

8. The formulation of claim 1 wherein said other nutrient is selected from a group consisting of Lutein, Lycopene, L-carnitine, and mixtures and combinations thereof.

9. The formulation of claim 1 wherein said formulation comprises a plurality of phytonutrients, said phytonutrients comprises of 1,000 mg of Bergmot, 200 mg of Cannabinoids, 20,000 mg Chokebery, 1,000 mg of Cinnamon, 500 mg of Curcummin, 100 mg of Flax Seed, 500 mg of Garlic, 500 mg of Ginseng, 500 mg of Ginger, 150 mg of Ginkgo biloba, 150 mg of Grape juice, 500 mg of Moringa, 250 mg of Resveratol, 450 mg of Spearmint, 500 mg of Spirulina, and 400 mg of Tea.

10. The formulation of claim 9 is for humans age 14 and older.

11. The formulation of claim 1 wherein said formulation comprises a plurality of phytonutrients, said phytonutrients comprises of 250 mg of Bergmot, 15 mg of Cannabinoids, 5,000 mg of Chokeberry, 100 mg of Cinnamon, 50 mg of Curcummin, 25 mg of Flax Seed, 50 mg of Garlic, 50 mg of Ginseng, 100 mg of Ginger, 10 mg of Ginkgo biloba, 50 mg of Grape juice, 100 mg of Moringa, 25 mg of Resveratol, 50 mg of Spearmint, 25 mg of Spirulina, and 100 mg of Tea.

12. The formulating of claim 11 is for humans ages 4 to ages 13.

13. The formulation of claim 9 wherein said hormone comprises of 2 mg of Melatonin.

14. The formulation of claim 13 is for humans age 14 and older.

15. The formulation of claim 11 wherein said hormone comprises of 0.5 mg of Melatonin.

16. The formulation of claim 15 is for humans between the ages of 4-13.

17. The formulation of claim 1 comprising a plurality of minerals, said minerals comprises of 250 mg of Calcium, 50 mcg of Chromium, 600 mg of Magnesium, 100 mcg of Selenium, and 10 mg of Zinc.

18. The formulation of claim 17 is for humans age 14 and older.

19. The formulation of claim 1 comprising a plurality of minerals, said minerals comprises of 100 mg of Calcium, 250 mg of Choline, 15 mcg of Chromium, 100 mcg of Iodine, 50 mg of Magnesium, 30 mcg of Selenium, and 5 mg of Zinc.

20. The formulation of claim 19 is for humans between the ages of 4-13.

21. The formulation of claim 1 comprising a plurality of dietary vitamins, said dietary vitamins comprises 3 mg of Vitamin B1, 4 mg of Vitamin B2, 20 mg of Vitamin B3, 8 mg of Vitamin B5, 4 mg of Vitamin B6, 100 mcg of Vitamin B7, 800 mcg of Vitamin B9, 8 mcg of Vitamin B12, and 600 IU of Vitamin D.

22. The formulation of claim 1 comprising a plurality of antioxidants, said antioxidants comprises 3,000 IU of Vitamin A, 500 mg Vitamin C, 300 IU of Vitamin E, 30 mg of Coenzyme Q10, and 15 mg of Natural mixed carotenoids.

23. The formulation of claim 1 comprising a plurality of glutathioine elevating agents, said glutathione elevating agents comprises 50 mg of Alpha-lipoic acid, 100 mg of L-cysteine, and 100 mg of N-acetylcysteine.

24. The formulation of claim 1 comprises a plurality of other nutrients, said other nutrients comprises 20 mg Lutein, 15 mg Lycopene, and 100 mg of L-carnitine.

25. The formulation of claim 21 is for humans age 14 and older.

26. The formulation of claim 1 comprising a plurality of dietary vitamins, said dietary vitamins comprises 1.5 mg of Vitamin B1, 1.6 mg of Vitamin B2, 12 mg of Vitamin B3, 5 mg of Vitamin B5, 2 mg of Vitamin B6, 50 mcg of Vitamin B7, 400 mcg of Vitamin B9, 4 mcg of Vitamin B12, and 400 IU of Vitamin D.

27. The formulation of claim 1 comprising a plurality of antioxidants, said antioxidants comprises 1,200 IU of Vitamin A, 125 mg Vitamin C, 40 IU of Vitamin E, 10 mg of Coenzyme Q10, and 4 mg of Natural mixed carotenoids.

28. The formulation of claim 1 comprising a plurality of glutathione elevating agents, said glutathione elevating agents comprises 20 mg of Alpha-lipoic acid, 12 mg of L-cysteine, and 12 mg of N-acetylcysteine.

29. The formulation of claim 1 comprises a plurality of other nutrients, said other nutrients comprises 5 mg Lutein, 3 mg Lycopene, and 50 mg of L-carnitine.

30. The formulation of claim 27 is for humans between the ages of 4-13.

31. A formulation consisting of phytonutrients, minerals, dietary vitamins, antioxidants, glutathione elevating agents and other nutrients, and combinations thereof comprising:
Bergamot in a range from about 10 mg to about 3,000 mg
Cannabinoids in a range from about 2 mg to about 2,000 mg
Cinnamon in a range from about 25 mg to about 8,000 mg
Curcumin in a range from about 5 mg to about 5,000 mg
Flax seed in a range from about 1 mg to about 6,000 mg
Garlic in a range from about 5 mg to about 6,000 mg
Ginseng in a range from about 5 mg to about 4,000 mg
Ginger in a range from about 25 mg to 4,000 mg
Ginkgo biloba in a range from about 0.1 mg to about 2,000 mg
Grape juice in a range from about 10 mg to 500 mg
Moringa in a range from about 1 mg to about 4,000 mg
Resveratrol in a range from about 1 mg to about 2,000 mg
Spearmint in a range from about 1 mg to about 1200 mg
Spirulina in a range from about 0.1 mg to about 6,000 mg
Tea in a range from 25 mg to about 2,000 mg
Calcium in a range from about 10 mg to about 2,500 mg
Chokeberry in a range from about 50 mg to about 50,000 mg
Choline in a range from about 0 mg to about 500 mg
Chromium in a range from about 0.1 mcg to about 250 mcg
Iodine in a range from about 0 mcg to about 250 mcg
Lutein in a range from about 0.1 mg to about 200 mg
Lycopene in a range from about 0.1 mg to about 200 mg
Magnesium in a range from about 5 mg to about 1,250 mg
Medium Chain Triglyceride in a range from about 1 mg to about 30,000 mg
Natural mixed carotenoids in a range from about 0.1 mg to about 100 mg
Selenium in a range from about 0.5 mcg to about 300 mcg
Zinc in a range from about 0.1 mg to about 60 mg
Alpha-lipoic acid in a range from about 0.5 mg to about 300 mg
Coenzyme Q10 from about 0.1 mg to about 350 mg
L-carnitine in a range from about 1 mg to about 6,000 mg
L-cysteine in a range from about 0.1 mg to about 1,500 mg
N-acetylcysteine in a range from about 0.1 mg to 1,500 mg
Vitamin A from a range of about 100 IU to about 6,000 IU
B1 in a range from about 0.1 mg to about 5 mg
B2 in a range from about 0.1 mg to about 6 mg
B3 in a range from about 0.1 mg to about 100 mg
B5 in a range from about 0.1 mcg to about 20 mcg
B6 in a range from about 0.1 mg to about 50 mg
B7 in a range from about 5 mcg to about 500 mcg
B9 in a range from about 50 mcg to about 2,000 mcg
B12 in a range from about 0.1 mcg to about 50 mcg
Vitamin C in a range from about 30 mg to about 4,000 mg
Vitamin D in a range from about 50 IU to about 4,000 IU
Vitamin E in a range from about 2 IU to about 1,000 IU
and combinations thereof.

32. The formulation of claim 31 having Melatonin in a range from about 0.1 mg to about 100 mg.

33. The formulation of claim 31 is made for humans from ages 4 and up.

34. A method of manufacturing a formulation, said method comprising admixing phytonutrients, minerals, dietary vitamins, antioxidants, glutathione elevating agents and other nutrient, and combinations thereof comprising:
Bergamot in a range from about 10 mg to about 3,000 mg
Cannabinoids in a range from about 2 mg to about 2,000 mg
Chokeberry in a range from about 50 mg to about 50,000 mg
Cinnamon in a range from about 25 mg to about 8,000 mg
Curcumin in a range from about 5 mg to about 5,000 mg
Flax seed in a range from about 1 mg to about 6,000 mg
Garlic in a range from about 5 mg to about 6,000 mg
Ginseng in a range from about 5 mg to about 4,000 mg
Ginger in a range from about 25 mg to 4,000 mg
Ginkgo biloba in a range from about 0.1 mg to about 2,000 mg
Grape juice in a range from about 10 mg to 500 mg
Moringa in a range from about 1 mg to about 4,000 mg
Resveratrol in a range from about 1 mg to about 2,000 mg
Spearmint in a range from about 1 mg to about 1200 mg
Spirulina in a range from about 0.1 mg to about 6,000 mg
Tea in a range from 25 mg to about 2,000 mg
Calcium in a range from about 10 mg to about 2,500 mg
Choline in a range from about 0 mg to about 500 mg
Chromium in a range from about 0.1 mcg to about 250 mcg
Iodine in a range from about 0 mcg to about 250 mcg
Lutein in a range from about 0.1 mg to about 200 mg
Lycopene in a range from about 0.1 mg to about 200 mg
Magnesium in a range from about 5 mg to about 1,250 mg
Medium Chain Triglyceride in a range from about 1 mg to about 30,000 mg
Natural mixed carotenoids in a range from about 0.1 mg to about 100 mg
Selenium in a range from about 0.5 mcg to about 300 mcg
Zinc in a range from about 0.1 mg to about 60 mg
Alpha-lipoic acid in a range from about 0.5 mg to about 300 mg
Coenzyme Q10 from about 0.1 mg to about 350 mg
L-carnitine in a range from about 1 mg to about 6,000 mg
L-cysteine in a range from about 0.1 mg to about 1,500 mg
N-acetylcysteine in a range from about 0.1 mg to 1,500 mg
Vitamin A from a range of about 100 IU to about 6,000 IU
B1 in a range from about 0.1 mg to about 5 mg
B2 in a range from about 0.1 mg to about 6 mg
B3 in a range from about 0.1 mg to about 100 mg
B5 in a range from about 0.1 mcg to about 20 mcg
B6 in a range from about 0.1 mg to about 50 mg
B7 in a range from about 5 mcg to about 500 mcg
B9 in a range from about 50 mcg to about 2,000 mcg
B12 in a range from about 0.1 mcg to about 50 mcg
Vitamin C in a range from about 30 mg to about 4,000 mg
Vitamin D in a range from about 50 IU to about 4,000 IU
Vitamin E in a range from about 2 IU to about 1,000 IU
and combinations thereof.

35. The method of manufacturing the formulation of claim 34 wherein a hormone is admixed and said hormone is Melatonin in a range from about 0.1 mg to about 100 mg.

36. The method of claim 34 for manufacturing a formulation for humans ages 4 and up.
